(19) United States
(12) Patent Application Publication
(10) Pub. No.: US 2016/0180277 A1
(43) Pub. Date: Jun. 23, 2016

(54) AUTOMATED RESPONSES TO PROJECTED CONTACT CENTER AGENT FATIGUE AND BURNOUT

(71) Applicant: Avaya Inc., Santa Clara, CA (US)

(72) Inventors: David Skiba, Golden, CO (US); Valentine C. Matula, Granville, OH (US); George Erhart, Loveland, CO (US)

(21) Appl. No.: 14/573,820

(22) Filed: Dec. 17, 2014

(51) Int. Cl. G06Q 10/06; H04M 3/51

(52) U.S. Cl. CPC G06Q 10/06398; H04M 3/5175; G06Q 10/063116; H04M 2203/402

(57) ABSTRACT

Agents of a contact center process work items for clients of the contact center. Agents may, at some point, experience “burnout.” Detecting early signs, and automatically mitigating the burnout allows agents to maintain interest in their work and avoid expensive training of new agents and lost experience of burnt-out agents. Agents may be monitored for single events and/or a pattern of events indicating burnout. Automatic detection and response to the burnout provides agents indicating burnout to have more interesting, less difficult, or otherwise more favorable working conditions. Feedback monitoring determines if the mitigation efforts are successful. If not, and an agent is burnt out and likely to quit, measures may be automatically launched to prevent the burnt-out agent from “infecting” other agents.

### FIELD OF THE DISCLOSURE

The present disclosure is generally directed toward work item routing in a contact center.

### BACKGROUND

Contact center work can be tedious, repetitive, stressful, and often boring. Contact centers struggle to implement approaches that strive to limit and manage agent burnout. Agents constantly have to manage interactions with customers while being monitored. Supervisor diligence in monitoring agents is one tool to appropriately manage rewards and avoid, or at least reduce, agent burnout. Agent burnout can lead to turnover and poor performance of unmotivated agents, which can be expensive to the operation of a contact center and negatively impact profitability, sales, branding, service levels, and customer satisfaction. Burnout also tends to spread and escalate if not addressed. Agent burnout and fatigue can also lead to higher agent turnover rates, necessitating expensive training of new hires.

Prior strategies used by contact centers to manage agent burnout include shifting an agent's work to focus on quality over speed and cost of completing work items, hire appropriate agent (e.g., using personality and soft skill tests), provide training including training on stress reduction and time management, managing agent occupancy, and employing the right number of positive managers to provide support and mentoring. While these efforts produce some positive results, problems remain.

### SUMMARY

It is with respect to the above issues and other problems that the embodiments presented herein were contemplated. Embodiments disclosed herein solve the above and other problems by providing, in part, automatic systems and means for detecting, and responding to, agent burnout. Detecting inputs and analysis may utilize voice characterization, typing rate, rankings, automatic questionnaires and/or other means to provide predictors of burnout in advance of an agent quitting. With respect to other embodiments disclosed herein, once an agent is identified as likely suffering from burnout, deploying means to mitigate the burnout of the agent and/or mitigate the effects of the agent's burnout on other agents and the operations of the contact center.

Inputs for which a system is operable to detect, collect, and analyze burnout indicators include, but are not limited to:
Agent speech off-call;
Agent speech during supervisor discussion and/or supervised/consultative transfer;
Speech characterization (voice based emotion detection, speech analysis, keywords)
Video characterization (gesture, posture, facial expression);
Questionnaire (stated state);
Ranking;
Overtime acceptance and efficiency; and/or
Accuracy of typing and typing rate.

The system is additionally automatically operable to provide positive incentives so that agents do not “game” the system. The system can use the predictive data to lighten the load of those agents who might otherwise take overtime when they shouldn't and/or provide agents with easier, more interesting, or otherwise more desirable work items. The system may change an agent's utilization and routing, including using the agents smartly as escalation agents or specialists that fulfill a specific need and provide additional challenges to head off boredom, fatigue, or burnout. In addition to notifications provided to automatic systems, alerts may be provided to supervisors as set by an administrator when indicators and thresholds are hit.

Alternately, if an agent is not responding to burnout countermeasures or an agent's actions provide indisputable evidence of burnout, embodiments disclosed herein, may automatically assign the agent more burnout-associated or difficult work, and thereby reduce the stress load on other agents, such as to reduce the burnout potential of the other agents. Scheduling systems may be modified to minimize the opportunity for the agent to socialize with other agents, such as by automatically adjusting breaks and/or work schedule. As a result of reducing the interactions between a burnt-out agent and his or her colleagues, the negative sentiment associated with the burnt-out agent has fewer opportunities to “infect” other agents.

In one embodiment, a system using the attributes derived from agent inputs, such as those described above, and the historical results of agent turnover, performance evaluations, and supervisor ratings, the system can build and maintain a model correlating the features and indicators to predict current and future agent fatigue and potential turnover.

The model created may be continuously updated based on the monitoring of agent performance and interactions with customers to provide a machine-learning system. While aspects of the model are generic in nature (e.g., behavior common to all or nearly all agents) there are aspects that may be specific to a single agent, a class of agents, a level of experience, etc. Using such a model, the system can be used to automatically alter the routing of work items to specific agents and notify supervisors of agents entering fatigue thresholds or agents predicted to become a turnover risk. A supervisor may be presented such information via a dashboard updated by the system. In one embodiment, the supervisors may adjust and/or approve any desired routing rules, staff schedules, etc. Results may also be integrated into any additional tools and applications to provide a comprehensive view (e.g., used in workforce planning, hiring, and scheduling).

In one non-limiting example, during a planning phase for the holiday season, a contact center manager may work through a list of agents to determine those agents eligible for overtime. Adding hours for an agent can be desirable for the agent to earn extra pay; however, the business need for quality service must be balanced. Incorporating current and predictive fatigue/burnout levels can help in the planning and monitoring of staff for, and throughout, the busy holiday week. Agents who working additional hours and continuing to perform well, and without burnout indicators, may continue to receive additional hours, normal work items, etc. Those agents who show signs of fatigue may have hours reduced and/or receive less stressful or more interesting work items.

In another non-limiting example, during the release of a new product, a contact center may suddenly undergo a heavy work load for a few days. As agents work longer hours and handle more calls, the system can monitor the interactions, noting the fatigue indicators and update the individual agent models and supervisor reports. When a few of the agents begin to reach dangerous fatigue levels, the supervisor is notified, as well as automatic changes to the routing rules (throttling) are implemented. The supervisor may take additional corrective actions for the current crisis, as well as revise scheduling for specific agents for the coming days to address the temporary call volumes. As a benefit, the corrective actions allow the company to save money and maintain/improve agent satisfaction before at-risk agents quit out of exhaustion and frustration.

In one embodiment, a system is disclosed, comprising: a memory operable to store accessible data and instructions; a network interface that interconnects the server to network components via a communication network; and a processor performing: accessing, via the network interface, an endpoint of an agent; receiving from the endpoint, a first action of the agent; determining whether the first action is associated with burnout; and upon determining the first action is associated with burnout, automatically modifying a work assignment of the agent, wherein the modification is a burnout mitigation modification.

In another embodiment, a processor is disclosed, performing operations comprising: accessing, via a network interface, an endpoint of an agent; receiving from the endpoint, a first action of the agent; determining whether the first action is associated with burnout; and upon determining the first action is associated with burnout, automatically causing a modification of a work assignment of the agent, wherein the modification is a burnout mitigation modification.

In still another embodiment, another processor is disclosed, comprising: means to store accessible data and processor executable instructions; means to interconnect to network components; and means to process data, including: accessing, via the interconnect means, an endpoint of an agent; receiving from the endpoint, a first action of the agent; determining whether the first action is associated with burnout; and upon determining the first action is associated with burnout, automatically modifying a work assignment of the agent, wherein the modification is a burnout mitigation modification.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 illustrates a first communication system in accordance with at least some embodiments of the present disclosure;

FIG. 2 illustrates a second communication system in accordance with at least some embodiments of the present disclosure;

FIG. 3 illustrates a work assignment system in accordance with at least some embodiments of the present disclosure;

FIG. 4 illustrates a burnout data scatter diagram with successful mitigation in accordance with at least some embodiments of the present disclosure;

FIG. 5 illustrates a burnout data scatter diagram with unsuccessful mitigation in accordance with at least some embodiments of the present disclosure; and

FIG. 6 illustrates a server of a communication system in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

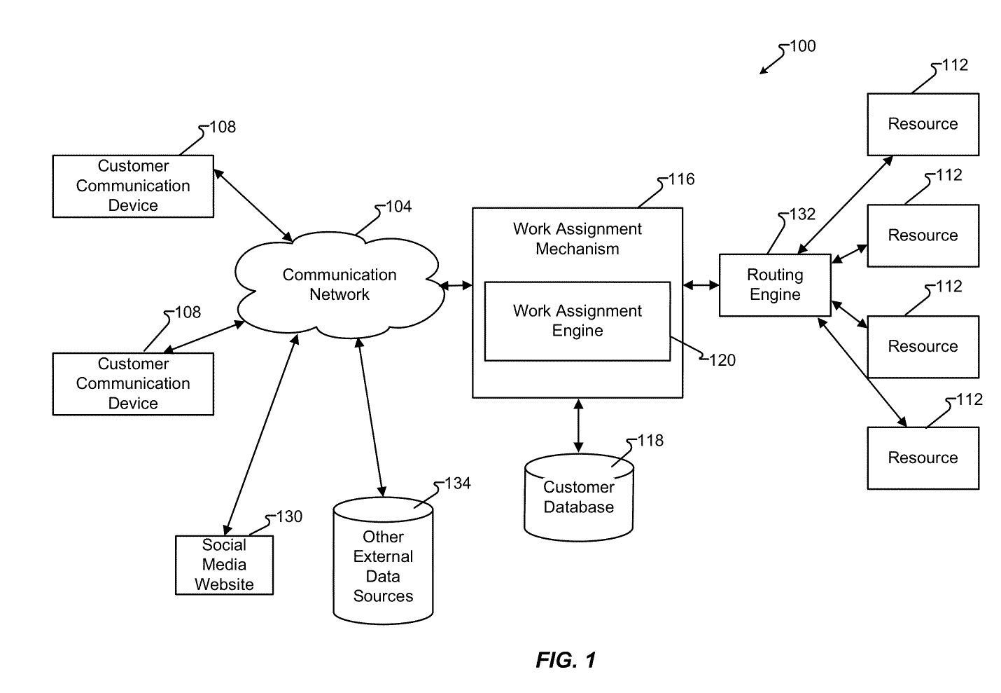

With reference now to FIG. 1, communication system 100 is discussed in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 and/or other external data sources 134 may be utilized to provide one means for a resource 112 to receive and/or retrieve contacts and connect to a customer of a contact center. Other external data sources 134 may include data sources such as service bureaus, third-party data providers (e.g., credit agencies, public and/or private records, etc.). Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to the contact center. Customer database 118 may be updated in response to a work item and/or input from resource 112 processing the work item.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

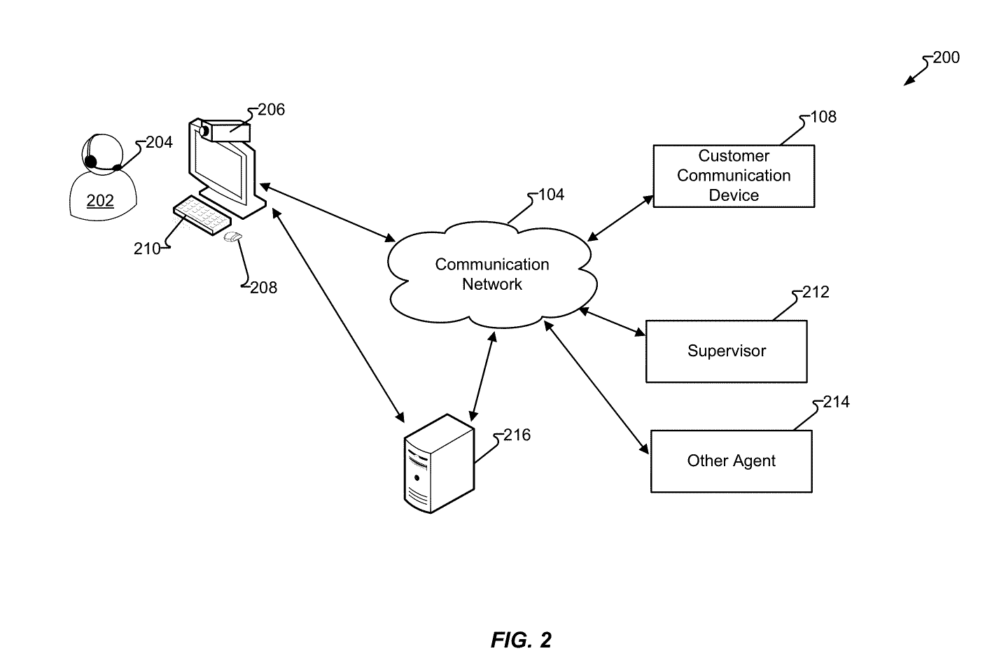

FIG. 2 illustrates communication system 200 in accordance with at least some embodiments of the present disclosure. In one embodiment agent 202 is a human agent resource 112. Agent 202 interacts with customer communication device 108. Agent 202 utilizes an endpoint comprising various inputs and sensing components. For example agent 202 may utilize microphone 204, keyboard 210, mouse 208, and/or camera 206. Other input devices may also be used such as touchpads, sensors, and joysticks. Input devices may be used to facilitate the interaction between agent 202 and customer communication device 108 and/or be used for internal operation of the contact center.

Input devices may be customized such as typing rate and/or pressure detectors associated with keyboard 210, mouse 208, and other tactile input devices (e.g., touchpad, track ball, joystick, etc.). As a benefit, agent 202 interacts with the input devices in a manner that may reveal mental states associated with burnout, such as frustration, lack of customer/coworker empathy, anger, indifference, fatigue, inability to concentrate, etc. Audio input device, microphone 204, may be associated with a voice stress analysis component operable to determine a level of stress associated with the speech of agent 202. Camera 206 may capture additional visual indicators of stress associated with burnout, for example, weaving of the hands, I motions, facial expressions, etc. Camera 206 may be operable to detect infrared images which may show heat patters of the agent's head and face, which may further indicate the agent is experiencing burnout.

In another embodiment, server 216 monitors agent 202 via the various input devices (e.g., microphone 204 alone or with the benefit of voice stress analysis components, camera 206, keyboard 210, mouse 208, etc.). Server 216 may interface directly with an endpoint associated with agent 202 and/or be connected directly or via the network, such as communications network 104.

Server 216 may analyze inputs associated with agent 202 and further associated with the performance of processing work items of the contact center. Additionally, time spent not associated with processing the work item (e.g., break times time between work items etc.) may be captured for analysis by server 216. The analysis performed by server 216 is variously embodied. In one embodiment a trend of burnout indicators over time may trigger a burnout mitigation activity. In other embodiments a specific instance of a burnout indicator may alone be sufficient as the burnout indicator. The burnout indicator may be derived from a single input, such as the pressure on keyboard 210, however, in other embodiments a combination of factors may be combined to determine a burnout indicator, such as typing rate with keystroke pressure utilizing keyboard 210.

One server 216 determines agent 202 is a candidate for burnout, that is, identified as suffering from burnout or is showing indicators associated with burnout, a response action to mitigate the burnout of agent 202 is selected and deployed by server 216. Server 216 may perform mitigation activities designed to mitigate the burnout potential of agent 202, alternatively, if agent 202 is part of a group of agents (e.g., agents addressing similar work items, etc.) additional mitigation activities may be applied to all agents within the group. As an example, server 202 may cause routing engine 132 to alter the work items sent to agent 202 and/or routing certain work items to other agent 214. Additionally, server 216 may notify supervisor 212 of the mitigating action and/or the burnout potential of agent 202. Additionally, server 216 may select an action to mitigate the burnout of agent 202 and, prior to execution, seek permission from supervisor 212 regarding mitigation activities.

In another embodiment, a classification of agents may be identified as indicating burnout without necessarily having indications from each agent within the class. The classification of agents, that includes agent 202, may then be the subject of mitigation activities. For example, agent 202 and related agents may be handling tax-related work items during tax preparation season or other high-stress, high-activity time frame. Agent 202 is identified as suffering from burnout, server 216 may determine that all agents associated with tax-related work items should receive some burnout mitigation activities which may be the same for all agents in the group or different for at least two agents. As a result, agent 202 may receive two non-tax related work items per shift, designed to provide variety and a break from tax-related work items, and all other agents processing tax-related work items, receive one non-tax related work item per shift.

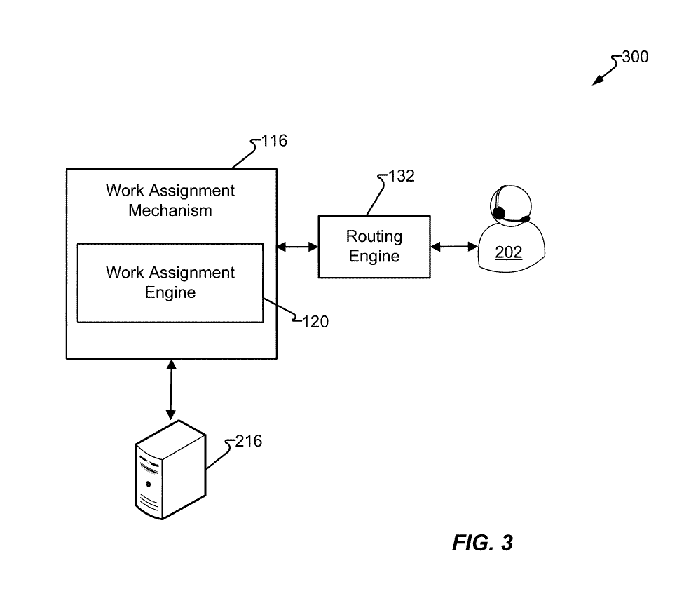

FIG. 3 illustrates work assignment system 300 in accordance with at least some embodiments of the present disclosure. In one embodiment, work assignment system 300 comprises portions of communication system 100 associated with routing work items in a contact center, such as to agent 202 for processing thereby. In one embodiment server 216 is in communication with work assignment mechanism 116 having work assignment engine 112. Work assignment engine 112 and/or routing engine 132 routes work items to a number of agents based upon the availability agent particulars, particular skills of the agent, particular needs of the work item, channel (e.g., text, voice-call, video-call, email, etc.), or other means for matching work items to agents for processing. Routing engine 112 manages the work use of agents such as agent 202 to manage workload, pacing, wait queue, etc.

Server 216, upon determining agent 202 is facing a burnout condition signals work assignment mechanism 116, work assignment engine 112, and/or routing engine 132 to alleviate stresses and/or increase variety or number of more interesting work items routed to agent 202. For example, agent 202 may have a particular interest in learning a new language and, following the signal of server 216 to work assignment mechanism 116 work assignment engine 112, or running engine 132 additional work items having that particular language associated there with our routed towards agent 202. In another example agent 202 may not like a particular subject matter and have fewer such calls routed to agent 202. In yet another example, agent 202 is particularly fond of a particular geographic region and, in response to a signal from server 216, receives more work items associated with customers from that particular geographic region.

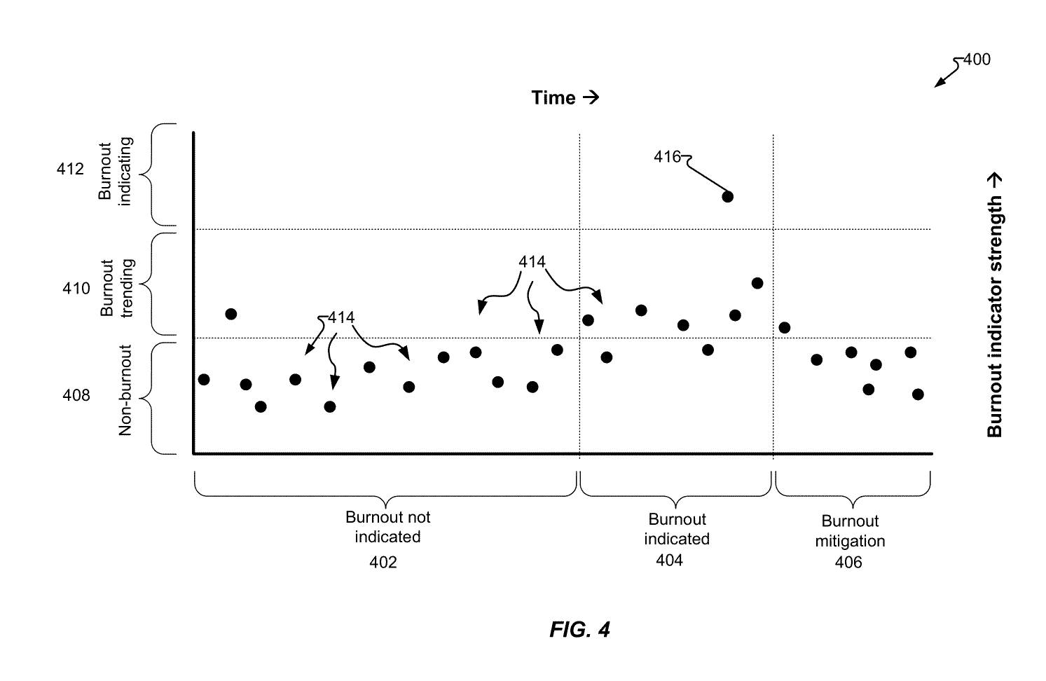

FIG. 4 illustrates burnout data scatter diagram 400 illustrating successful mitigation in accordance with at least some embodiments of the present disclosure. In one embodiment diagram 400 includes a number of data points 414. Data points 414 are plotted over time in burnout not indicated time 402, burnout indicated time 404, and burnout mitigation time 406. Data points are associated with burnout trends plotted on the y-axis of at least one agent, such as agent 202.

Agent 202 performs work activities, not associated with a burnout activity, for example data points 414 falling within non-burnout area 408. A single outlier data point 414 may be ignored if either not a sufficient by itself to indicate a burnout. As agent 202, becomes more stressed or otherwise provides more of an indication of burnout, data points 414 begin to climb up the y-axis such as into burnout trending area 410 and burnout indicating area 412.

As time passes in the next phase, such as burnout indicated time 404, data points 414 show an increasing trend, as well as one specific incident 416 in the burnout indicating area 412. Server 216 may conclude that agent 202 is suffering from burnout and select and launch at least one mitigating activity designed to reduce the burnout potential of the of agent 202.

After the mitigation activity is launched, data points 414 are continued to be plotted on diagram 400. In burnout mitigation time 406, the trend of data points 414 shows trend downward with few data points 404 in burnout trending area 410, no data points 414 in burnout indicating area 412, and most data points 414 in non-burnout area 408. Server 216 may then determine the mitigating activities to be successful and if warranted discontinue the mitigating activities if it is likely the burnout potential has passed. Alternatively the mitigating activities may be maintained. Server 216 may associate the mitigation activities, and the success thereof, with attributes of agent 202, the work items, or other aspect of the contact center. As a benefit, the activity launched to begin burnout mitigation time 406 may be selected again, or more likely to be selected, based on the success illustrated by diagram 400.

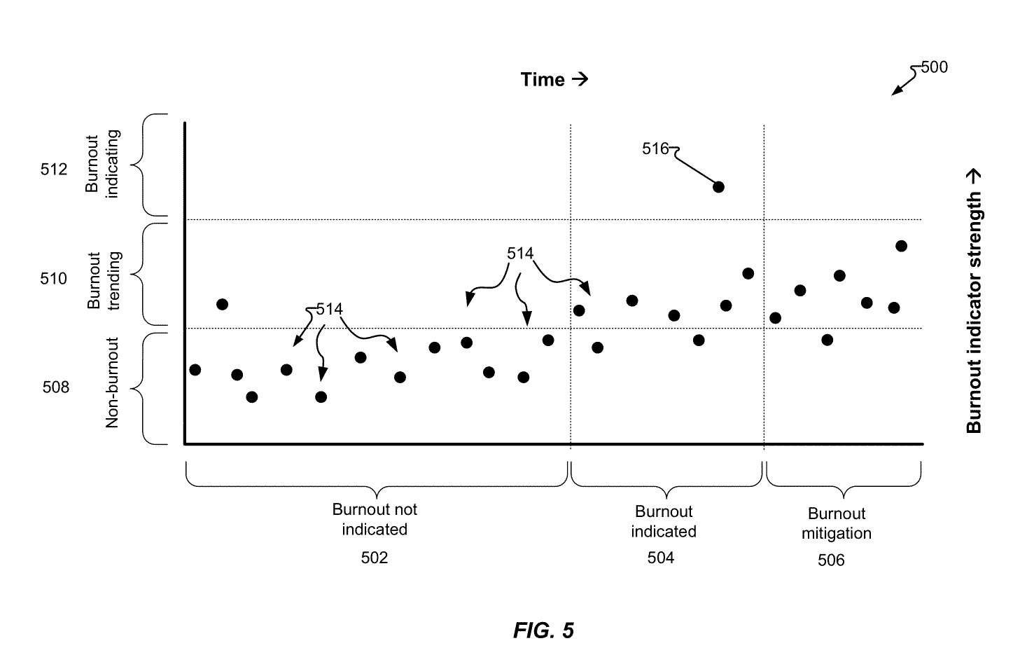

FIG. 5 illustrates burnout data scatter diagram 500 illustrating unsuccessful mitigation in accordance with at least some embodiments of the present disclosure. Diagram 500 shows data points 514 plotted over time on the x-axis and burnout severity plotted on the y-axis. Over time a particular set of data, data points 514, progress from burnout not indicated time 502, burnout indicated time 504, to burnout mitigation time 506. The severity is divided into non-burnout area 508, burnout trending area 510, and burnout indicating area 512. A particular set of data points, such as data point 514 for agent 202 are shown. Data points 514 show a trend over time as increasing from non-burnout area 508, towards burnout trending area 510, to to burnout indicated time 504.

In one embodiment burnout indicating area 512 contains data point 516 which may be a specific incidence of a burnout indicating activity that, by itself, is sufficient to indicate a burnout. For example the associated agent, agent 202, may have expressed a desire to quit verbally which was picked up on microphone 204 and may or may not have been associated with an interaction with customer communication device 108, supervisor 112, or other agent 214. For example agent 202 may simply have muttered, “I need to quit this job,” at a time between work items. As with diagram 400, single data points in burnout trending area 510 may be insufficient to indicate burnout and no action taken until such time as the outlier increases in severity, that is, is higher on the y-axis, or is associated with a trend or group of indicating data points 514.

Server 216 decides to take action and launch a mitigation activity beginning burnout mitigation time 506. However, burnout mitigation time 506 illustrates data points 514 continuing within the burnout trending area 510 and may even continue to trend upward. As a result, server 216 may conclude that the burnout mitigation activities executing in burnout indicated area 506, were not successful. In one embodiment server 216 may implement another mitigation activity or an alternative mitigation activity. In yet another embodiment server 216 may determine agent 202 has burnt out and will soon be quitting their position as an agent.

In one embodiment, server 216, upon determining that a particular agent, such as agent 202, has become burnout and no other mitigation activities are to be taken, server 216 may implement strategies to mitigate the impact of the burnout on other agents. For example agent 202 may be rescheduled to work at times designed to minimize social interactions with other agents, for example, by altering a shift by a few minutes so that other agents coming and going to work are less likely to interact with agent 202. In another embodiment agent 202 is assigned more difficult tasks generally associated with increasing a potential for burnout based on historical observations so as to relieve pressure on other agents.

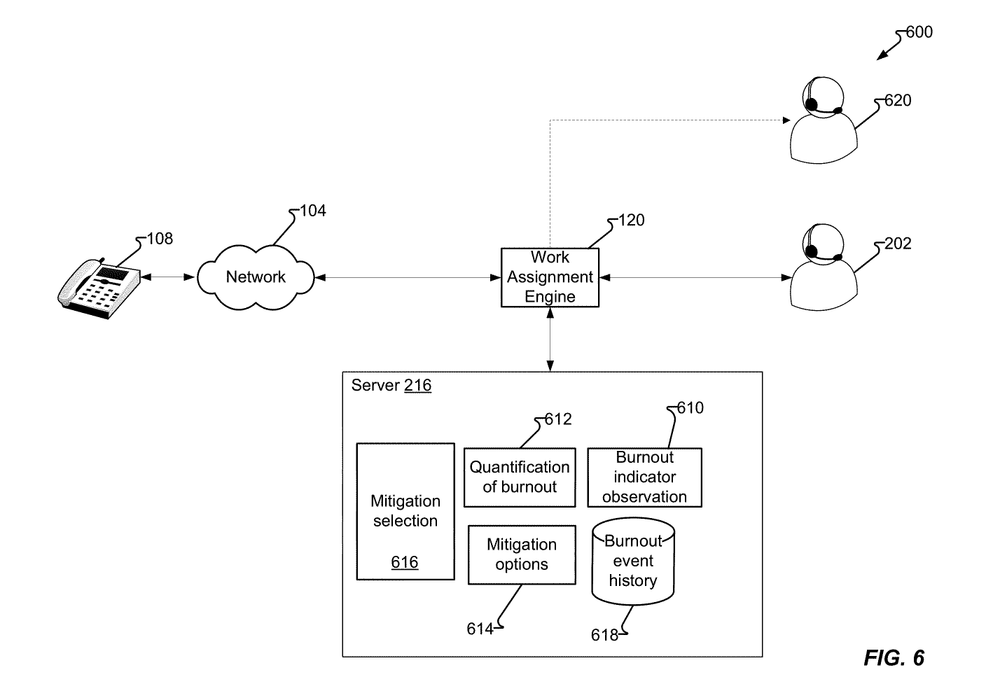

FIG. 6 illustrates server 216 of communication system 600 in accordance with at least some embodiments of the present disclosure. Server 216 comprises a network interface, operable to exchange electronic data between server 216 and other components of the contact center, at least one processor, and an accessible memory for use by the processor and/or other components. Accessible memory may be integrated into server 216 and/or external to server 216. In one embodiment, server 216 comprises a number of components, such as, burnout indicator observation 610, quantification of burnout 612, mitigation options 614, burnout event history 618, and mitigation selection 616. Server 216 communicate with work assignment engine 120 such as to cause work assignment engine to alter its routing algorithm for providing work items to agent 202 and or other agents such as agent 620. As a result customer communication device 118 utilizing communications network 104 providing work item to work assignment engine 120 is then routed at least in part upon the input of server 216 to either agent 202 or agent 620.

Server 216 comprises burnout indicator observation 610. Burnout indicator observation 610 is variously embodied to be associated with one or more input devices such as microphone 204 camera 206, keyboard 210, mouse 208, and/or other input or sensing device. Burnout indicator observation 610 may comprise a keyboard pressure monitor, a voice stress analysis component, facial recognition, eye tracking, facial expression determination, or other indicator associated with stress which is further associated with burnout of agents of a contact center. Quantification of burnout 612, in one embodiment, is operable to determine the severity indicated by burnout indicator observation 610. For example, quantification of burnout 612 may determine that an increase pressure of typing on keyboards 210 or a change of typing rate on keyboard 210 alone have no predictive value. However, a pressure or rate change above a previously determined threshold and/or in combination with another endpoint input, such as a typing rate change indicator, may be quantified as a burnout.

In one embodiment, mitigation options 614 provide various mitigation options to server 216 to execute to mitigate the burnout of agent 202. Mitigation options 614 may include, for example, changing a routing of work items by work assignment engine 120, changing work hours associated with agent 202, utilizing agent 202 for other tasks (e.g., escalation, review, supervisory, etc.), or other actions as may be appropriate. In another example mitigation option 614 may include notification of a supervisor, such a supervisor 212, to cause supervisor 212 to perform actions such as approve another mitigation option suggested by mitigation option 614 or to initiate other actions. In another embodiment, burnout event history 618 provides a historic record of activities associated with one or more agents, such as agent 202. For example as agent 202 progresses in time and becomes less satisfied with their work data points associated with their performance may begin to indicate a trend predicting burnout in the future. Mitigation events that burnout event history 618 may also be associated with events common to multiple agents, including but not limited to, certain types of work items, certain shifts, certain modes of communication with customer communication device 108 (for example, videoconferencing). For example, agents who work on “project A” for ten weeks may be known to be candidates for burnout and monitored much more frequently and/or have a lower threshold of indicated burnout as compared to agents who are working on other projects or campaigns.

In another embodiment, mitigation selection 616 selects a mitigation option from mitigation option 614. Mitigation selection 616 may further consider burnout event history 618, as well as burnout quantification 612 as inputs to select the one or more mitigating activities. Mitigation selection 616 executes and causes server 612 to notify work assignment engine 120 and/or other systems of the contact center in accord with the mitigation activity. For example, server 216 may cause agent 620 to utilize agent 202 as an escalation agent in order to provide agent 202 with more challenging work.

Mitigation selection 616 may also determined that agent 202 has burnt out and cause server 216 to signal work assignment engine 120 to route work items to agent 202 having a higher propensity towards burnout to relieve the workload on agent 620.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a memory operable to store accessible data and instructions;
a network interface that interconnects the server to network components via a communication network; and
a processor performing:
accessing, via the network interface, an endpoint of an agent;
receiving from the endpoint, a first action of the agent;
determining whether the first action is associated with burnout; and
upon determining the first action is associated with burnout, automatically modifying a work assignment of the agent, wherein the modification is a burnout mitigation modification.

2. The system of claim 1, wherein the processor further performs:
monitoring, after the modification of the work assignment of the agent, the endpoint for a second action;
determining whether the second action is associated with burnout; and
upon determining the second action is associated with burnout, automatically modifying a work assignment of the agent, wherein the modification is a terminating mitigation modification.

3. The system of claim 2, wherein the terminating mitigation modification is the assignment of at least one work item to the agent selected to mitigate burnout with respect to at least one other agent not associated with the endpoint.

4. The system of claim 2, wherein the processor further performs storing indicia of the second action and indicia of the burnout mitigation modification and an associated indicia of the failure of the burnout mitigation modification.

5. The system of claim 1, wherein 1 the burnout mitigation modification is a modification of the work assigned to the agent to provide the agent with at least one of escalated actions, variety of work items, more positive sentiment work items, fewer negative sentiment work items, and reduced workload.

6. The system of claim 1, wherein the processor further performs:
monitoring, after the modification of the work assignment of the agent, the endpoint for a second action;
determining whether the second action is associated with burnout; and
upon determining the second action is not associated with burnout, automatically modifying a work assignment of the agent, wherein the modification is a normalization modification negating, at least in part, the burnout mitigation modification.

7. The system of claim 6, wherein the processor further performs storing indicia of the second action and indicia of the burnout mitigation modification and an associated indicia of the success of the burnout mitigation modification.

8. The system of claim 1, wherein the processor further performs, signaling, via the network interface, a supervisor terminal associated with a supervisor of the agent wherein the signal is an indicia of burnout.

9. The system of claim 1, wherein the first action is at least one of speech of the agent and non-speech vocalization.

10. The system of claim 1, wherein the first action is at least one of speech of the agent, non-speech vocalization, communication from the agent to a supervisor, communication from the agent to a consultative agent, questionnaire response, rank, acceptance of overtime, acceptance of shift changes, acceptance of work duty changes, typing rate, and typing accuracy.

11. The system of claim 1, wherein the processor determines whether the first action is associated with burnout action upon determining a trend of actions, comprising the first action, indicates burnout.

12. A processor, performing operations comprising:
accessing, via a network interface, an endpoint of an agent;
receiving from the endpoint, a first action of the agent;
determining whether the first action is associated with burnout; and
upon determining the first action is associated with burnout, automatically causing a modification of a work assignment of the agent, wherein the modification is a burnout mitigation modification.

13. The processor of claim 12, performing operations further comprising:
monitoring, after the modification of the work assignment of the agent, the endpoint for a second action;
determining whether the second action is associated with burnout; and
upon determining the second action is associated with burnout, automatically modifying a work assignment of the agent, wherein the modification is a terminating mitigation modification.

14. The processor of claim 13, wherein the terminating mitigation modification is the assignment of at least one work item to the agent selected to mitigate burnout with respect to at least one other agent not associated with the endpoint.

15. The processor of claim 12, wherein the processor further performs storing indicia of the second action and indicia of the burnout mitigation modification and an associated indicia of the failure of the burnout mitigation modification.

16. The processor of claim 12, wherein the first action is at least one of speech of the agent, non-speech vocalization, communication from the agent to a supervisor, communication from the agent to a consultative agent, questionnaire response, rank, acceptance of overtime, acceptance of shift changes, acceptance of work duty changes, facial expression, typing rate, typing force, and typing accuracy.

17. A processor, comprising:
means to store accessible data and processor executable instructions;
means to interconnect to network components; and
means to process data, including:
accessing, via the interconnect means, an endpoint of an agent;
receiving from the endpoint, a first action of the agent;
determining whether the first action is associated with burnout; and
upon determining the first action is associated with burnout, automatically modifying a work assignment of the agent, wherein the modification is a burnout mitigation modification.

18. The processor of claim 17, wherein the processing means determines further comprises means to determine whether the first action is associated with burnout action upon determining a trend of actions, comprising the first action, indicates burnout.

19. The system of claim 17, wherein the processor means further comprises means to perform signaling, via the interconnect means, a supervisor terminal associated with a supervisor of the agent wherein the signal is an indicia of burnout.

20. The system of claim 17, wherein the first action is at least one of speech of the agent and non-speech vocalization.
